(19) United States
(12) Patent Application Publication
(10) Pub. No.: US 2023/0057655 A1
(43) Pub. Date: Feb. 23, 2023

(54) THREE-DIMENSIONAL RANGING METHOD AND DEVICE

(71) Applicant: RAYZ TECHNOLOGIES CO. LTD., BEIJING (CN)

(72) Inventors: Detao Du, Beijing (CN); Ruxin Chen, Beijing (CN)

(73) Assignee: RAYZ TECHNOLOGIES CO. LTD., BEIJING (CN)

(21) Appl. No.: 17/789,990

(22) PCT Filed: Dec. 29, 2020
(86) PCT No.: PCT/CN2020/140953

§ 371 Date: Jun. 29, 2022

(30) Foreign Application Priority Data
Dec. 30, 2019 (CN) 201911397605.8

(51) Int. Cl. G01S 17/894; G06V 10/82; G01S 7/481; G01S 17/10; G06V 10/74; G06V 10/143; G01S 17/931

(52) U.S. Cl. CPC G01S 17/894; G06V 10/82; G01S 7/4816; G01S 17/10; G06V 10/761; G06V 10/143; G01S 17/931

(57) ABSTRACT

The present disclosure provides a three-dimensional distance measurement method and device. A three-dimensional distance measurement device includes: at least a light source unit, configured to emit light pulses to illuminate a scene to be measured; at least an optical transmission unit, configured to control transmission of a reflected light obtained after the light pulses are reflected by an object in the scene to be measured; at least a photoreceptor unit, configured to receive a light transmitted through the optical transmission unit to perform imaging; and at least a processor unit, configured to control the light source unit, the optical transmission unit and the photoreceptor unit, and to determine scene distance information of the scene to be measured based on an imaging result of the photoreceptor unit.

### TECHNICAL FIELD

The present disclosure relates to the field of optical distance measurement, and more particularly, the present disclosure relates to a three-dimensional distance measurement method and a three-dimensional distance measurement device.

### BACKGROUND

With the emergence of application scenarios such as autonomous driving, 3D videos and games, smartphone navigation, and intelligent robots, it is becoming more and more important to perform depth measurement of a scene in real time and accurately.

Currently, there are various methods for measuring the depth of a scene. The distance resolution of the traditional triangulation distance measurement degrades continuously with the increase of distance. With the development of laser technology, the use of laser to measure the depth of a scene has become common. One method includes transmitting a modulated optical signal to the scene to be measured, receiving the light reflected by an object in the scene to be measured, and then determining the distance of the object in the scene to be measured by demodulating the received light. Because this method is a point-to-point measurement method, a large number of scanning are required to obtain the depth information of the scene, and the spatial resolution of this method is limited. Another method uses a light in a predetermined illumination mode to illuminate the scene to be measured, and uses the calibration information obtained in advance to obtain depth information of the scene to be measured. In addition, another method is time-of-flight distance measurement method, which includes transmitting a modulated signal and obtaining the relative phase offset of the returned signal with respect to the transmitted signal using four sensors associated with a single photosensitive pixel at four different phases of the modulated signal, so as to determine the depth information.

These above distance measurement methods generally require dedicated hardware configurations, the distance measurement device is bulky and cumbersome, and the spatial resolution of the distance measurement is low, or the distance measurement field of view is narrow, or the distance of the distance measurement is short.

### SUMMARY

The present disclosure is made to address the above-mentioned problems. The present disclosure provides a three-dimensional distance measurement method and a three-dimensional distance measurement device.

According to an aspect of the present disclosure, a three-dimensional distance measurement device is provided, three-dimensional distance measurement device includes: a light source unit, configured to emit light pulses to illuminate a scene to be measured; an optical transmission unit, configured to control transmission of a reflected light obtained after the light pulses are reflected by an object in the scene to be measured; a photoreceptor unit, configured to receive a light transmitted through the optical transmission unit to perform imaging; and a processor unit, configured to control the light source unit, the optical transmission unit and the photoreceptor unit, and to determine scene distance information of the scene to be measured based on an imaging result of the photoreceptor unit. The light pulses include at least a first light pulse and a second light pulse, and a ratio of a first processed pulse envelope, which is obtained by processing a first pulse envelope of the first light pulse by the optical transmission unit, to a second processed pulse envelope, which is obtained by processing a second pulse envelope of the second light pulse by the optical transmission unit, is a monotonic function varying with time.

Furthermore, in the three-dimensional distance measurement device according to at least one embodiment of the present disclosure, the light source unit is configured to simultaneously or sequentially emit light pulses of different wavelengths, different polarizations, and different spatial structures and/or different temporal structures.

Furthermore, in the three-dimensional distance measurement device according to at least one embodiment of the present disclosure, the photoreceptor unit is configured to perform pixel-by-pixel or region-by-region imaging simultaneously or sequentially.

Furthermore, in the three-dimensional distance measurement device according to at least one embodiment of the present disclosure, the photoreceptor unit is configured to acquire a first scene image corresponding to the first light pulse, a second scene image corresponding to the second light pulse, and a background scene image of the scene to be measured; and the processor unit is configured to acquire the scene distance information of the scene to be measured based on the background scene image, the first scene image and the second scene image.

Furthermore, in the three-dimensional distance measurement device according to at least one embodiment of the present disclosure, the background scene image includes a background scene image obtained by imaging the scene to be measured in a wavelength band not comprising a wavelength of the first light pulse nor a wavelength of the second light pulse, and/or a background scene image obtained by imaging the scene to be measured in a wavelength band comprising wavelengths of the first light pulse and the second light pulse without the first light pulse and the second light pulse being emitted.

Furthermore, in the three-dimensional distance measurement device according to at least one embodiment of the present disclosure, the processor unit is configured to generate a target region image corresponding to a target region including a plurality of sub-regions based on the first scene image, the second scene image and the background scene image, while the sub-regions comprise of simple primitives and/or superpixel regions and/or pixels; and the processor unit is configured to generate scene distance information of the target region based on the first scene image, the second scene image and the target region image.

Furthermore, in the three-dimensional distance measurement device according to at least one embodiment of the present disclosure, the target region image is generated using a deep neural network.

Furthermore, in the three-dimensional distance measurement device according to at least one embodiment of the present disclosure, the deep neural network is pre-optimized to perform sub-region segmentation based on the first scene image, the second scene image and the background scene image and generate the scene distance information based on the first scene image, the second scene image and the background scene image.

Furthermore, in the three-dimensional distance measurement device according to at least one embodiment of the present disclosure, deep neural network is updated in real time utilizing real-world scene images, further utilizing sub-region data with labels generated by a virtual three-dimensional world simulation corresponding to the real-world scene images, further utilizing a pre-labelled real-world image and corresponding sub-region label data, and/or further utilizing scene images and label data collected by at least one other three-dimensional distance measurement device.

Furthermore, in the three-dimensional distance measurement device according to at least one embodiment of the present disclosure, an output of the deep neural network is calibrated with label data of a simulated virtual 3D world as simple primitives and/or superpixel sub-regions including 3D information, and the simple primitives and/or superpixel sub-regions are used to generate the scene distance information for the target region.

Furthermore, the three-dimensional distance measurement device according to at least one embodiment of the present disclosure further includes a beam splitter unit, which is configured to guide the reflected light reflected by the object in the scene to be measured to the optical transmission unit, and to guide the reflected light reflected by the object in the scene to be measured to the photoreceptor unit; the photoreceptor unit includes at least a first photoreceptor sub-unit and a second photoreceptor sub-unit, the first photoreceptor sub-unit is configured to perform imaging on the reflected light, and the second photoreceptor sub-unit is configured to perform imaging on a reflected light of a natural light; the first photoreceptor sub-unit is at least further configured to perform imaging on spatially uneven light pulses to generate an uneven light pulse scene image; and the scene distance information is generated based on the background scene image, at least the first scene image and the second scene image, the target region image, and/or the uneven light pulse scene image.

Furthermore, in the three-dimensional distance measurement device according to at least one embodiment of the present disclosure, the three-dimensional distance measurement device is installed on a vehicle, and the light source unit is configured as a left headlight and/or a right headlight of the vehicle.

Furthermore, in the three-dimensional distance measurement device according to at least one embodiment of the present disclosure, the optical transmission unit includes a first optical transmission sub-unit and a second optical transmission sub-unit, and the photoreceptor unit includes a first photoreceptor sub-unit and a second photoreceptor sub-unit; the three-dimensional distance measurement device further includes a first beam splitter sub-unit and a second beam splitter sub-unit; the first optical transmission sub-unit, the first beam splitter sub-unit and the first photoreceptor sub-unit form a first sub optical path for imaging the light pulses; the second optical transmission sub-unit, the second beam splitter sub-unit and the second photoreceptor sub-unit form a second sub optical path for imaging a visible light; the processor unit is configured to control alternate imaging or simultaneous imaging via the first sub optical path and/or the second sub optical path; and the scene distance information is generated based on the background scene image, the first scene image and the second scene image, and the target region image.

Furthermore, the three-dimensional distance measurement device according to at least one embodiment of the present disclosure further includes an amplifier unit, which is configured after the light source unit for amplifying the light pulses, or configured after the first optical transmission sub-unit or the first beam splitter sub-unit for amplifying the reflected light.

Furthermore, in the three-dimensional distance measurement device according to at least one embodiment of the present disclosure, the processor unit is further configured to output the scene distance information and a scene image of the scene to be measured, and the scene image includes at least one of the group consisting of an image of geometric figures and an optical flow image.

According to another aspect of the present disclosure, a three-dimensional distance measurement method is provided, and the three-dimensional distance measurement method includes: emitting light pulses to illuminate a scene to be measured; controlling transmission of a reflected light obtained after the light pulses are reflected by an object in the scene to be measured; receiving a light transmitted through the transmission to perform imaging; and determining scene distance information of the scene to be measured based on a result of the imaging; the light pulses include at least a first light pulse and a second light pulse, and a ratio of a first processed pulse envelope, which is obtained by processing a first pulse envelope of the first light pulse, to a second processed pulse envelope, which is obtained by processing a second pulse envelope of the second light pulse, is a monotonic function varying with time.

Furthermore, in the three-dimensional distance measurement method according to at least one embodiment of the present disclosure, emitting the light pulses includes: simultaneously or sequentially emitting light pulses of different wavelengths, different polarizations, and different spatial structures and/or different temporal structures.

Furthermore, the three-dimensional distance measurement method according to at least one embodiment of the present disclosure further includes: performing pixel-by-pixel or region-by-region imaging simultaneously or sequentially.

Furthermore, the three-dimensional distance measurement method according to at least one embodiment of the present disclosure further includes: acquiring a first scene image corresponding to the first light pulse, a second scene image corresponding to the second light pulse, and a background scene image of the scene to be measured; and acquiring the scene distance information of the scene to be measured based on the background scene image, the first scene image and the second scene image.

Furthermore, in the three-dimensional distance measurement method according to at least one embodiment of the present disclosure, the background scene image includes a background scene image obtained by imaging the scene to be measured in a wavelength band not comprising a wavelength of the first light pulse nor a wavelength of the second light pulse, and/or a background scene image obtained by imaging the scene to be measured in a wavelength band comprising wavelengths of the first light pulse and the second light pulse while without the first light pulse and the second light pulse being emitted.

Furthermore, the three-dimensional distance measurement method according to at least one embodiment of the present disclosure further includes: generating a target region image corresponding to a target region comprising a plurality of sub-regions based on the first scene image, the second scene image and the background scene image, and generating scene distance information of the target region based on the first scene image, the second scene image and the target region image.

Furthermore, the three-dimensional distance measurement method according to at least one embodiment of the present disclosure further includes: pre-optimizing a deep neural network to perform sub-region segmentation based on the first scene image, the second scene image and the background scene image and generate the scene distance information based on the first scene image, the second scene image and the background scene image.

Furthermore, the three-dimensional distance measurement method according to at least one embodiment of the present disclosure further includes: updating the deep neural network in real time utilizing real-world scene images, further utilizing sub-region data with labels generated by a virtual three-dimensional world simulation corresponding to the real-world scene images, further utilizing a pre-labelled real-world image and corresponding sub-region label data, and/or further utilizing scene images and label data collected by at least one other three-dimensional distance measurement device.

Furthermore, in the three-dimensional distance measurement method according to at least one embodiment of the present disclosure, an output of the deep neural network is calibrated with label data of a simulated virtual 3D world as simple primitives and/or superpixel sub-regions comprising 3D information, and the simple primitives and/or superpixel sub-regions are used to generate the scene distance information for the target region.

Furthermore, the three-dimensional distance measurement method according to at least one embodiment of the present disclosure further includes: guiding the reflected light reflected by the object in the scene to be measured to the optical transmission unit, and guiding the reflected light reflected by the object in the scene to be measured to the photoreceptor unit; the photoreceptor unit includes at least a first photoreceptor sub-unit and a second photoreceptor sub-unit, the first photoreceptor sub-unit is configured to perform imaging on the reflected light, and the second photoreceptor sub-unit is configured to perform imaging on a reflected light of a natural light; the first photoreceptor sub-unit is at least further configured to perform imaging on spatially uneven light pulses to generate an uneven light pulse scene image; and the scene distance information is generated based on the background scene image, at least the first scene image and the second scene image, the target region image, and/or the uneven light pulse scene image.

Furthermore, in the three-dimensional distance measurement method according to at least one embodiment of the present disclosure, the optical transmission unit includes a first optical transmission sub-unit and/or a second optical transmission sub-unit, and the photoreceptor unit includes a first photoreceptor sub-unit and/or a second photoreceptor sub-unit; the three-dimensional distance measurement device further includes a first beam splitter sub-unit and a second beam splitter sub-unit; the first optical transmission sub-unit, the first beam splitter sub-unit and the first photoreceptor sub-unit form a first sub optical path for imaging the light pulses; the second optical transmission sub-unit, the second beam splitter sub-unit and the second photoreceptor sub-unit form a second sub optical path for imaging a visible light; the three-dimensional distance measurement method further includes: controlling alternate imaging or simultaneous imaging via the first sub optical path and/or the second sub optical path; and the scene distance information is generated based on the background scene image, the first scene image and the second scene image, and the target region image.

Furthermore, the three-dimensional distance measurement method according to at least one embodiment of the present disclosure further includes: outputting the scene distance information and a scene image of the scene to be measured, and the scene image includes at least one of the group consisting of an image of geometric figures and an optical flow image.

As will be described in detail below, the three-dimensional distance measurement method and the three-dimensional distance measurement device according to a embodiments of the present disclosure achieve accurate and real-time depth information acquisition without scanning and without subjecting to a narrow field-of-view limitation by using a normal CCD or CMOS image sensor with controllable illumination and sensor exposure imaging. In addition, because no additional mechanical components are used, and the components such as CCD or CMOS can be mass-produced, thereby increasing the reliability and stability of the system while reducing the cost.

It is to be understood that both the foregoing general description and the following detailed description are exemplary and are intended to provide further explanation of the claimed technology.

### BRIEF DESCRIPTION OF THE DRAWINGS

The above and other objects, features and advantages of the present disclosure will become more apparent from the more detailed description of the embodiments of the present disclosure in conjunction with the accompanying drawings. The drawings are used to provide a further understanding of the embodiments of the present disclosure, and constitute a part of the specification, and are used to explain the present disclosure together with the embodiments of the present disclosure, and do not constitute a limitation to the present disclosure. In the drawings, the same reference numerals generally represent the same components or steps.

FIG. 1 is a schematic diagram summarizing an application scenario of a three-dimensional distance measurement method and a three-dimensional distance measurement device according to at least one embodiment of the present disclosure;

FIG. 2 is a flowchart summarizing a three-dimensional distance measurement method according to at least one embodiment of the present disclosure;

FIG. 3 is a schematic diagram further illustrating an application scenario of a three-dimensional distance measurement method and a three-dimensional distance measurement device according to at least one embodiment of the present disclosure;

FIG. 4 is a schematic diagram further illustrating an application scenario of a three-dimensional distance measurement method and a three-dimensional distance measurement device according to at least one embodiment of the present disclosure;

FIG. 5 is a schematic diagram further illustrating an application scenario of a three-dimensional distance measurement method and a three-dimensional distance measurement device according to at least one embodiment of the present disclosure; and

FIG. 6 is a flowchart further illustrating a three-dimensional distance measurement method according to at least one embodiment of the present disclosure.

### DETAILED DESCRIPTION

In order to make the objects, technical solutions and advantages of the present disclosure more apparent, exemplary embodiments according to the present disclosure will be described in detail below with reference to the accompanying drawings. Obviously, the described embodiments are only a part of the embodiments of the present disclosure, not all of the embodiments of the present disclosure, and it should be understood that the present disclosure is not limited by the exemplary embodiments described herein.

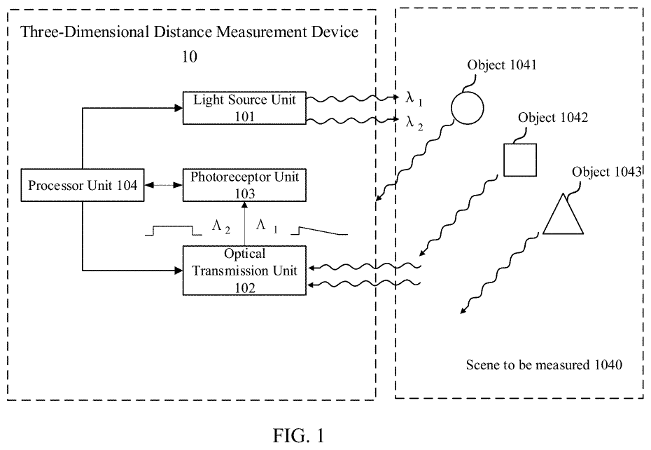

First, an application scenario of the present disclosure is schematically described with reference to FIG. 1. FIG. 1 is a schematic diagram summarizing an application scenario of a three-dimensional (3D) distance measurement method and device according to at least one embodiment of the present disclosure.

As shown in FIG. 1, the three-dimensional distance measurement device 10 according to at least one embodiment of the present disclosure performs distance measurement on a scene to be measured 1040. In one embodiment of the present disclosure, the three-dimensional distance measurement device 10 is, for example, configured in autonomous driving system. The three-dimensional distance measurement device 10 measures the relative distance of objects in the driving scene of the vehicle (for example, street, highway, etc.), and the obtained distance information of the scene will be used for the implementation of functions such as unmanned driving positioning, drivable region detection, lane marking line detection, obstacle detection, dynamic object tracking, and obstacle classification and recognition. In another embodiment of the present disclosure, the three-dimensional distance measurement device 10 is, for example, configured in an AR/VR video game system. The three-dimensional distance measurement device 10 performs scene distance information measurement on the environment where the user is located, so as to accurately locate the user's position in the three-dimensional space and enhance the real experience in the game. In another embodiment of the present disclosure, the three-dimensional distance measurement device 10 is, for example, configured in an intelligent robot system. The three-dimensional distance measurement device 10 performs scene distance information measurement on the working environment where the robot is located, thereby implementing modeling of the working environment where the robot is located and intelligent path planning of the robot.

As schematically shown in FIG. 1, the three-dimensional distance measurement device 10 according to at least one embodiment of the present disclosure includes a light source unit 101, an optical transmission unit 102, a photoreceptor unit 103, and a processor unit 104.

The light source unit 101 is configured to emit light pulses λ1, λ2 to illuminate the scene to be measured 1040. In the embodiments of the present disclosure, according to actual specific application scenarios, the light source unit 101 is configured to simultaneously or sequentially emit light pulses with different wavelengths, different polarizations, and different spatial structures (for example, structured light) and/or different temporal structures (Frequency Modulated Continuous Wave, FMCW) under the control of the processor unit 104. In one embodiment of the present disclosure, the three-dimensional distance measurement device 10 is installed on a vehicle, and the light source unit 101 is configured as a left headlight and/or a right headlight of the vehicle.

The optical transmission unit 102 is configured to control transmission of a reflected light obtained after the light pulses are reflected by an object in the scene to be measured. In the embodiments of the present disclosure, according to actual specific application scenarios, the optical transmission unit 102 is configured to allow light pulses of a specific wavelength and polarization to pass through, and to process the envelope of the passed light pulses, under the control of the processor unit 104. In the embodiments of the present disclosure, the optical transmission unit 102, for example, is implemented as an optical gate.

The photoreceptor unit 103 is configured to receive a light transmitted through the optical transmission unit 120 to perform imaging. In the embodiments of the present disclosure, according to actual specific application scenarios, the photoreceptor unit 103 is configured to perform pixel-by-pixel or region-by-region imaging simultaneously or sequentially under the control of the processor unit 104. In the embodiments of the present disclosure, the photoreceptor unit 103 is, for example, provided with RGBL filters for every four pixels (RGB filters corresponding to normal visible light spectrum while L corresponding to the laser spectrum), so as to simultaneously record images by visible light and laser. Alternatively, the photoreceptor unit 103 includes photoreceptor sub-units for visible light and laser, respectively.

The processing unit 104 is configured to control the light source unit 101, the optical transmission unit 102 and the photoreceptor unit 103, and to determine scene distance information of the scene to be measured 1040 based on an imaging result of the photoreceptor unit 103.

As schematically shown in FIG. 1, the light pulses include at least a first light pulse λ1, and a second light pulse λ2, and the ratio of a first processed pulse envelope Λ1, which is obtained by processing a first pulse envelope of the first light pulse λ1 by the optical transmission unit 102, to a second processed pulse envelope Λ2, which is obtained by processing a second pulse envelope of the second light pulse λ2 by the optical transmission unit 102, is a monotonic function varying with time. The first processed pulse envelope Λ1 is, for example, a monotonically falling ramp wave of the light pulse envelope over time, while the second processed pulse envelope Λ2 is, for example, a square wave whose light pulse envelope is invariant with time. Alternatively, the first processed pulse envelope Λ1 is also a falling or rising ramp wave of the light pulse envelope over time, while the second processed pulse envelope Λ2 is a rising or falling ramp wave different from the first processed pulse envelope Λ1. That is, in the three-dimensional distance measurement method according to the embodiment of the present disclosure, it is necessary to satisfy that the ratio of the first processed pulse envelope Λ1 to the second processed pulse envelope Λ2 is a monotonic function varying with time. The monotonic functional relationship between the first processed pulse envelope Λ1 and the second processed pulse envelope Λ2 will be recorded for subsequent scene distance information determination by the processor unit 104.

The principle of determining the scene distance information by using at least two light pulses whose envelopes have a monotonic function relationship is described as follows.

A first light pulse is emitted at time t=0, the duration of the first light pulse is Δ1, and the light pulse envelope of the first light pulse is f1(t). That is, t=0 is a first light emission start time, and Δ1 is a first light emission end time. It is assumed that there are two objects in the scene to be measured, namely object 1 which is relatively far away and object 2 which is relatively close, and the surface reflectivity of the objects are assumed to be R1 and R2 respectively. For object 1, starting from time T1, the first light pulse reflected by the object 1 starts to return. (T1+t11) is a first exposure start time, and (T1+t12) is a first exposure end time. For object 2, starting from time T2, the first light pulse reflected by the object 2 starts to return. (T2+t21) is a first exposure start time, and (T2+t22) is a first exposure end time. The difference between the first exposure start time and the first exposure end time is a first exposure time τ1 for the first light pulse. In addition, for the object 1, the distances over which the first light pulse is emitted and reflected are r11 and r12, respectively; and for the object 2, the distances over which the first light pulse is emitted and reflected are r21 and r22, respectively.

Similarly, a second light pulse is emitted at time t=0, the duration of the second light pulse is Δ2, and the light pulse envelope of the second light pulse is f2(t). That is, t=0 is a second light emission start time, and Δ2 is a second light emission end time. It is to be understood that the illustration of the first light pulse and the second light pulse as both being emitted at time t=0 is merely schematic, and the first light pulse and the second light pulse may be emitted simultaneously or sequentially. For the object 1, starting from time T3, the second light pulse reflected by the object 1 starts to return. (T3+t31) is a second exposure start time, and (T3+t32) is a second exposure end time. For the object 2, starting from time T4, the second light pulse reflected by the object 2 starts to return. (T4+t41) is a second exposure start time, and (T4+t42) is a second exposure end time. The difference between the second exposure start time and the second exposure end time is a second exposure time τ2 for the second light pulse, which may be equal to the first exposure time T1 of the first light pulse.

In this way, the exposure amounts 1 and 2 of the first light pulse to the pixel 1 on the object 1 and the pixel 2 on the object 2 can be expressed as follows.

$$Exposure amount 1 = \frac{{R}_{1} \cdot {\int }_{T 1 + t 11}^{T 1 + t 12} f 1 ( t ) \cdot dt}{{C}_{1} \cdot π \cdot {( r 11 + r 12 )}^{4}} \qquad Eq . 1$$

$$Exposure amount 2 = \frac{{R}_{2} \cdot {\int }_{T 2 + t 21}^{T 2 + t 22} f 1 ( t ) \cdot dt}{{C}_{2} \cdot π \cdot {( r 21 + r 22 )}^{4}} \qquad Eq . 2$$

The exposure amounts 3 and 4 of the second light pulse to the pixel 1 on the object 1 and the pixel 2 on the object 2 can be expressed as follows.

$$Exposure amount 3 = \frac{{R}_{1} \cdot {\int }_{T 3 + t 31}^{T 3 + t 32} f 2 ( t ) \cdot dt}{{C}_{1} \cdot π \cdot {( r 11 + r 12 )}^{4}} \qquad Eq . 3$$

$$Exposure amount 4 = \frac{{R}_{2} \cdot {\int }_{T 4 + t 41}^{T 4 + t 42} f 2 ( t ) \cdot dt}{{C}_{2} \cdot π \cdot {( r 21 + r 22 )}^{4}} \qquad Eq . 4$$

Among them, C1 and C2 are constants, which are spatially related to pixels 1 and 2 and have nothing to do with time. It is easy to understand that the image output values obtained by imaging the pixel 1 and the pixel 2 are proportional to the respective exposure amounts.

In at least one embodiment of the present disclosure, the first exposure time is controlled to satisfy a first predetermined duration, so that at least a part of the first light pulse reflected through each point in the scene to be measured can be used in the first exposure time to acquire a first scene image, and the second exposure time is controlled to satisfy a second predetermined duration, so that at least a part of the second light pulse reflected through each point in the scene to be measured can be used in the second exposure time to acquire a second scene image.

For one pixel 1 or one pixel 2, in the ideal case without considering the background light exposure, the exposure amount ratio g of the two exposures by the first light pulse and the second light pulse is expressed as follows.

$${g}_{1} ( D ) = \frac{- Exposure amount 1}{Exposure amount 3} = \frac{{\int }_{T 1 + t 11}^{T 1 + t 12} f 1 ( t ) \cdot dt}{{\int }_{T 3 + t 31}^{T 3 + t 32} f 2 ( t ) \cdot dt} \qquad Eq . 5$$

$${g}_{2} ( D ) = \frac{Exposure amount 2}{Exposure amount 4} = \frac{{\int }_{T 2 + t 21}^{T 2 + t 22} f 1 ( t ) \cdot dt}{{\int }_{T 4 + t 41}^{T 4 + t 42} f 2 ( t ) \cdot dt} \qquad Eq . 6$$

In the case where the background light exposure is considered, the exposure amount ratio g of the two exposures by the first light pulse and the second light pulse is expressed as follows.

$${g}_{1} ( D ) = \frac{Exposure amount 1 - background 1}{Exposure amount 3 - background 3} = \frac{{\int }_{T 1 + t 11}^{T 1 + t 12} f 1 ( t ) \cdot dt - background 1}{{\int }_{T 3 + t 31}^{T 3 + t 32} f 2 ( t ) \cdot dt - background 2} \qquad Eq . 7$$

$${g}_{2} ( D ) = \frac{Exposure amount 2 - background 2}{Exposure amount 4 - background 4} = \frac{{\int }_{T 2 + t 21}^{T 2 + t 22} f 1 ( t ) \cdot dt - background 2}{{\int }_{T 4 + t 41}^{T 4 + t 42} f 2 ( t ) \cdot dt - background 4} \qquad Eq . 8$$

In Eq. 7 and Eq. 8, background 1, background 2, background 3, and background 4 represent background light exposure 1, background light exposure 2, background light exposure 3, and background light exposure 4, respectively. T1 to T4 are all related to the distance D, and t11, t12, t31, t32, t21, t22, t41, t42, τ1 and τ2 are controllable parameters, then it is only necessary to control f1(t)/f2(t) to satisfy a monotonic change function, then g(D) becomes a monotonic function of distance D. Therefore, for a particular pixel, by measuring two exposures of the pixel, the distance information D of the pixel can be determined by the ratio of the two exposures.

Therefore, under the condition that the ratio of the first processed pulse envelope, which is obtained by processing the first pulse envelope of the first light pulse by the optical transmission unit, to the second processed pulse envelope, which is obtained by processing the second pulse envelope of the second light pulse by the optical transmission unit, is a monotonic function varying with time, the photoreceptor unit 103 acquires a first scene image M2 corresponding to the first light pulse, a second scene image M3 corresponding to the second light pulse, and a background scene image of the scene to be measured 1040 (as described below including M1 and M4), and the processor unit 104 acquires the scene distance information of the scene to be measured 1040 based on the background scene images (M1 and M4), the first scene image M2 and the second scene image M3.

Specifically, the background scene image is a background scene image obtained by imaging the scene to be measured in a wavelength band not including a wavelength of the first light pulse nor a wavelength of the second light pulse (that is, regardless of the presence or absence of laser pulse emission, the photoreceptor unit 103 is controlled not to perform imaging in the laser pulse band, but only in the natural light band to obtain the background scene image M4), and/or a background scene image obtained by imaging the scene to be measured in a wavelength band including wavelengths of the first light pulse and the second light pulse while without the first light pulse and the second light pulse being emitted (that is, in the case of no laser pulse emission, the photoreceptor unit 103 is controlled to perform imaging in the laser pulse band, and not perform imaging in the natural light band to obtain the background scene image M1).

In at least one embodiment of the present disclosure, the processor unit 104 is configured to generate a target region image M5 corresponding to a target region including a plurality of sub-regions based on the first scene image M2, the second scene image M3 and the background scene images (M1 and M4), and the processor unit 104 is configured to generate the scene distance information of the target region based on the first scene image M2, the second scene image M3 and the target region image M5. In the embodiment, the processor unit 104 uses a pre-trained neural network to perform sub-region segmentation on the target region in the scene to be measured based on the first scene image M2, the second scene image M3 and the background scene images (M1 and M4), and automatically performs scene distance information generation.

In at least one embodiment of the present disclosure, the output of the deep neural network is calibrated with label data of a simulated virtual 3D world as simple primitives and/or superpixel sub-regions including 3D information, and the simple primitives and/or superpixel sub-regions are used to generate the scene distance information for the target region. Usually, the output target (label data) of a general neural network for image recognition is a block diagram (boundary) of an object and the name of the object represented by the block diagram such as apple, tree, person, bicycle, car, and so on, and the output in the present embodiment is simple primitives such as triangles, rectangles, circles, and so on. In other words, in the processing of the three-dimensional distance measurement device, the target object is identified/simplified into “simple primitives” (including bright spots and dimensions, so-called “simple primitives”), and both the original image and the simple primitives are a part of the scene distance information that is generated for the target region.

Further, in the whole process of processing, the deep neural network is updated in real time utilizing real-world scene images, further utilizing sub-region data with labels generated by a virtual three-dimensional world simulation corresponding to the real-world scene images, further utilizing a pre-labelled real-world image and corresponding sub-region label data, and/or further utilizing scene images and label data collected by at least one other three-dimensional distance measurement device.

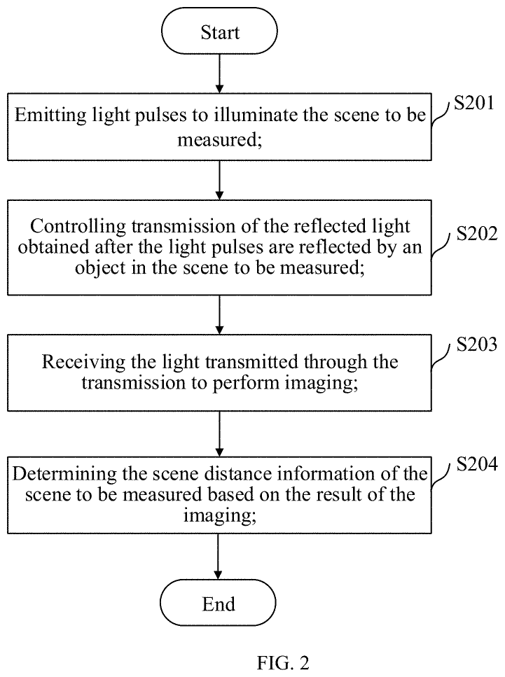

FIG. 2 is a flowchart summarizing a three-dimensional distance measurement method according to at least one embodiment of the present disclosure. FIG. 2 is a basic flowchart of a three-dimensional distance measurement device according to at least one embodiment of the present disclosure with reference to FIG. 1.

As shown in FIG. 2, a three-dimensional distance measurement method according to at least one embodiment of the present disclosure includes the following steps.

In step S201, emitting light pulses to illuminate the scene to be measured.

In the embodiments of the present disclosure, according to actual specific application scenarios, the light pulses with different wavelengths, different polarizations, and different spatial structures (for example, structured light) and/or different temporal structures (Frequency Modulated Continuous Wave, FMCW) are emitted simultaneously or sequentially.

In step S202, controlling transmission of the reflected light obtained after the light pulses are reflected by an object in the scene to be measured.

In the embodiments of the present disclosure, according to actual specific application scenarios, the light pulses of a specific wavelength and polarization are allowed to pass through, and the envelope of the passed light pulses is processed.

In step S203, receiving the light transmitted through the transmission to perform imaging.

In the embodiments of the present disclosure, according to actual specific application scenarios, the pixel-by-pixel or region-by-region imaging is performed simultaneously or sequentially. In the embodiments of the present disclosure, the photoreceptor unit 103 is, for example, provided with RGBL filters for every four pixels (RGB filters corresponding to normal visible light spectrum while L corresponding to the laser spectrum), so as to simultaneously record images by visible light and laser. Alternatively, the photoreceptor unit 103 includes photoreceptor sub-units for visible light and laser, respectively.

In step S204, determining the scene distance information of the scene to be measured based on the result of the imaging.

In the embodiments of the present disclosure, the light pulses include at least a first light pulse and a second light pulse, and the ratio of a first processed pulse envelope, which is obtained by processing a first pulse envelope of the first light pulse by the optical transmission unit, to a second processed pulse envelope, which is obtained by processing a second pulse envelope of the second light pulse by the optical transmission unit, is a monotonic function varying with time.

According to the basic distance measurement principle described in FIG. 1 above, in step S203, the first scene image M2 corresponding to the first light pulse, the second scene image M3 corresponding to the second light pulse, and the background scene images (M1 and M4) are acquired. In step S204, the scene distance information of the scene to be measured is acquired based on the background scene image, the first scene image and the second scene image.

More specifically, in at least one embodiment of the present disclosure, in step S204, a pre-optimized deep neural network is used to generate the target region image M5 corresponding to the target region including a plurality of sub-regions based on the first scene image M2, the second scene image M3 and the background scene images (M1 and M4), and the scene distance information of the target region is generated based on the first scene image M2, the second scene image M3 and the target region image M5.

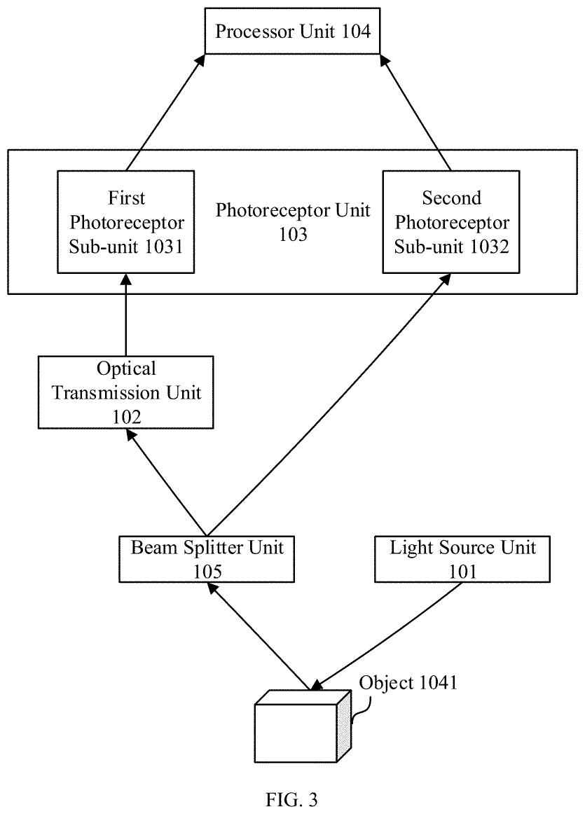

In the following, specific application scenarios of the three-dimensional distance measurement method and device according to the embodiments of the present disclosure are described with further reference to FIG. 3 to FIG. 5.

FIG. 3 is a schematic diagram further illustrating an application scenario of a three-dimensional distance measurement method and device according to the embodiments of the present disclosure. As shown in FIG. 3, the three-dimensional distance measurement device 10 according to at least one embodiment of the present disclosure further includes a beam splitter unit 105, which is configured to guide the reflected light reflected by the object 1041 in the scene to be measured to the optical transmission unit 102, and to guide the light reflected by the object 1041 in the scene to be measured to the photoreceptor unit 103. The photoreceptor unit 103 includes at least a first photoreceptor sub-unit 1031 and a second photoreceptor sub-unit 1032. The first photoreceptor sub-unit 1031 is configured to perform imaging on the reflected light in the laser band. For example, in the case of no laser pulse emission, the first photoreceptor sub-unit 1031 performs imaging in the laser pulse band, but does not perform imaging in the natural light band to obtain the background scene image M1; and in the case of laser pulse emission, the first photoreceptor sub-unit 1031 acquires the first scene image M2 corresponding to the first light pulse λ1 and the second scene image M3 corresponding to the second light pulse λ2. The second photoreceptor sub-unit 1032 is configured to perform imaging on the reflected light of the natural light. For example, regardless of whether laser pulses are emitted, the second photoreceptor sub-unit 1032 does not perform imaging in the laser pulse band, but only performs imaging in the natural light band to obtain the background scene image M4. In addition, the first photoreceptor sub-unit 1031 is at least further configured to perform imaging on spatially uneven light pulses to generate an uneven light pulse scene image.

The processor unit 104 configured with deep neural network performs sub-region segmentation on the target region based on the background scene images (M1 and M4), at least the first scene image M2 and the second scene image M3, generates the target region image M5, and obtains the scene distance information. In at least one embodiment of the present disclosure, the scene distance information is presented as 3D distance point cloud map R(i, j)=F(M1, M2, M3, M4, M5, M6). The three-dimensional distance measurement device 10 according to an embodiment of the present disclosure outputs a 2D visual image and a 3D distance point cloud map.

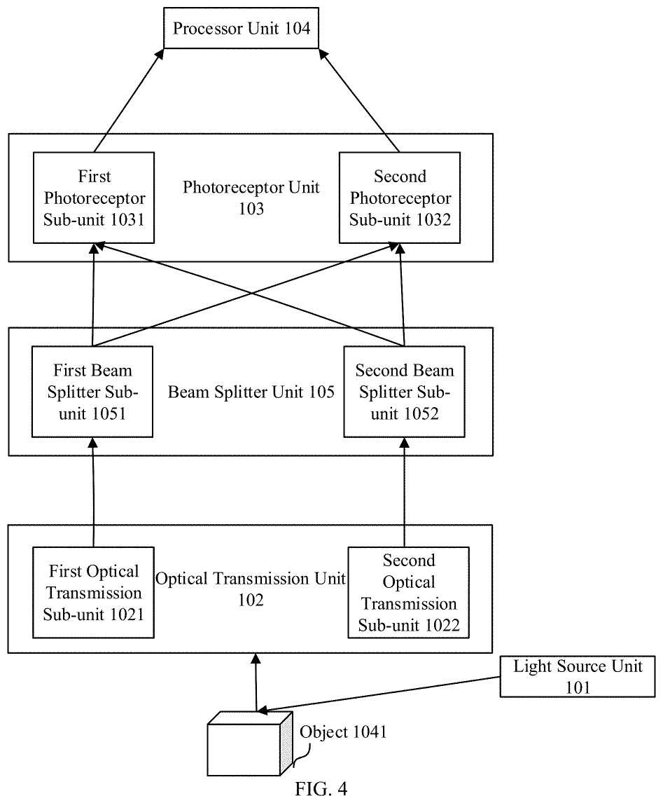

FIG. 4 is a schematic diagram further illustrating an application scenario of a three-dimensional distance measurement method and device according to at least one embodiment of the present disclosure. As shown in FIG. 4, the optical transmission unit 102 of the three-dimensional distance measurement device 10 according to at least one embodiment of the present disclosure further includes a first optical transmission sub-unit 1021 and a second optical transmission sub-unit 1022. The first optical transmission sub-unit 1021 and the second optical transmission sub-unit 1022 are configured with different light passing functions, so as to perform different processing on the envelopes of the passing laser pulses. When performing imaging in laser band, light pulses of the corresponding band are allowed to pass, and when performing imaging in visible light band, the visible light of the corresponding band is allowed to pass. The photoreceptor unit 103 includes a first photoreceptor sub-unit 1031 and a second photoreceptor sub-unit 1032. The first photoreceptor sub-unit 1031 and the second photoreceptor sub-unit 1032 may perform exposure alternately to improve spatial pixel matching accuracy. In addition, the first photoreceptor sub-unit 1031 and the second photoreceptor sub-unit 1032 may perform exposure at the same time to improve the distance measurement accuracy of dynamic objects. In addition, the beam splitter unit 105 of the three-dimensional distance measurement device 10 further includes a first beam splitter sub-unit 1051 and a second beam splitter sub-unit 1052. The first beam splitter sub-unit 1051 and the second beam splitter sub-unit 1052 can be used to separate laser and visible light, and can controllably separate laser pulses of different wavelengths, polarizations, and angles. It is easy to understand that the number and arrangement positions of the above-mentioned components are not limited.

The first optical transmission sub-unit 1021, the first beam splitter sub-unit 1051 and the first photoreceptor sub-unit 1031 form a first sub optical path for imaging the light pulses; and the second optical transmission sub-unit 1022, the second beam splitter sub-unit 1052 and the second photoreceptor sub-unit 1032 form a second sub optical path for imaging the visible light. The processor unit 104 is configured to control alternate imaging or simultaneous imaging via the first sub optical path and/or the second sub optical path. The processor unit 104 configured with a deep neural network generates the scene distance information based on at least the background scene images (M1 and M4), at least the first scene image M2 and the second scene image M3, and the target region image M5.

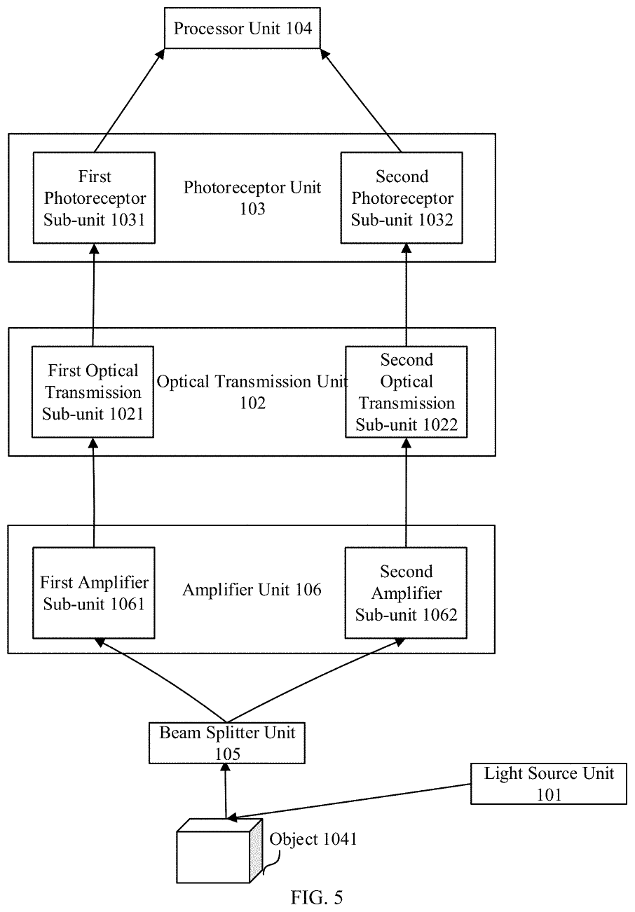

FIG. 5 is a schematic diagram further illustrating an application scenario of a three-dimensional distance measurement method and device according to at least one embodiment of the present disclosure. As shown in FIG. 5, the three-dimensional distance measurement device 10 according to an embodiment of the present disclosure is further configured with an amplifier unit 106 (including a first amplifier sub-unit 1061 and a second amplifier sub-unit 1062), which is configured after the light source unit 101 for amplifying the light pulses, or configured after the first optical transmission sub-unit 1021 or the beam splitter unit 105 for amplifying the reflected light.

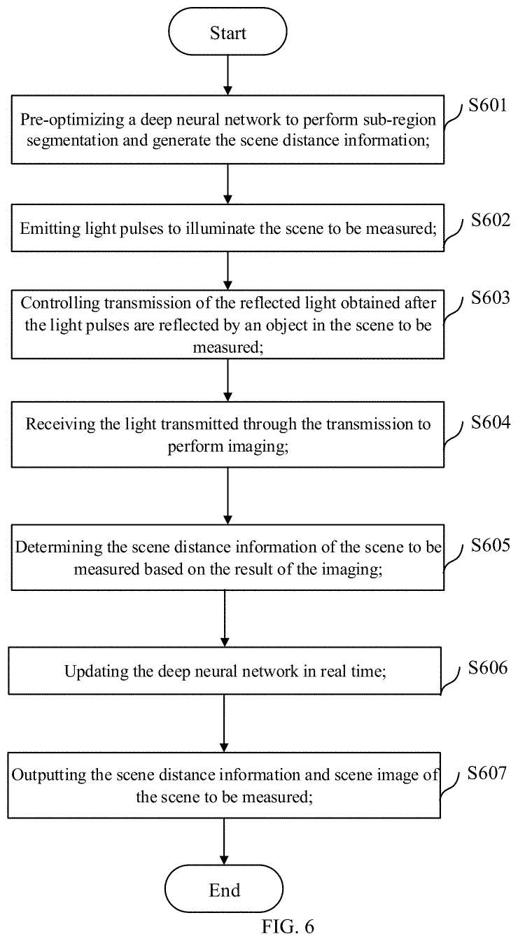

FIG. 6 is a flowchart further illustrating a three-dimensional distance measurement method according to at least one embodiment of the present disclosure.

As shown in FIG. 6, the three-dimensional distance measuring method according to yet another embodiment of the present disclosure includes the following steps.

In step S601, pre-optimizing a deep neural network to perform sub-region segmentation and generate the scene distance information.

That is, the three-dimensional distance measurement method according to yet another embodiment of the present disclosure needs to perform training on the deep neural network for distance measurement.

In step S602, emitting light pulses to illuminate the scene to be measured.

In the embodiments of the present disclosure, according to actual specific application scenarios, the light pulses with different wavelengths, different polarizations, and different spatial structures (for example, structured light) and/or different temporal structures (Frequency Modulated Continuous Wave, FMCW) are emitted simultaneously or sequentially.

In step S603, controlling transmission of the reflected light obtained after the light pulses are reflected by an object in the scene to be measured.

In the embodiments of the present disclosure, according to actual specific application scenarios, the light pulses of a specific wavelength and polarization are allowed to pass through, and the envelope of the passed light pulses is processed. Specifically, for example, the configurations described with reference to FIG. 3 to FIG. 5 can be employed.

In step S604, receiving the light transmitted through the transmission to perform imaging.

In the embodiments of the present disclosure, according to actual specific application scenarios, the pixel-by-pixel or region-by-region imaging is performed simultaneously or sequentially. In the embodiments of the present disclosure, the photoreceptor unit 103 is, for example, provided with RGBL filters for every four pixels (RGB filters corresponding to normal visible light spectrum while L corresponding to the laser spectrum), so as to simultaneously record images by visible light and laser. Alternatively, the photoreceptor unit 103 includes photoreceptor sub-units for visible light and laser, respectively.

In step S605, determining the scene distance information of the scene to be measured based on the result of the imaging.

In the embodiments of the present disclosure, the light pulses include at least a first light pulse and a second light pulse, and the ratio of a first processed pulse envelope, which is obtained by processing a first pulse envelope of the first light pulse by the optical transmission unit, to a second processed pulse envelope, which is obtained by processing a second pulse envelope of the second light pulse by the optical transmission unit, is a monotonic function varying with time.

According to the basic distance measurement principle described in FIG. 1 above, in step S604, the first scene image M2 corresponding to the first light pulse, the second scene image M3 corresponding to the second light pulse, and the background scene images (M1 and M4) are acquired. In step S605, the scene distance information of the scene to be measured is acquired based on the background scene image, the first scene image and the second scene image.

More specifically, in at least one embodiment of the present disclosure, in step S605, the deep neural network pre-optimized in step S601 is used to generate the target region image M5 including a plurality of sub-regions based on the first scene image M2, the second scene image M3 and the background scene images (M1 and M4), and generate the scene distance information of the target region based on the first scene image M2, the second scene image M3 and the target region image M5.

In step S606, updating the deep neural network in real time.

More specifically, in the embodiments of the present disclosure, the deep neural network is updated in real time utilizing real-world scene images acquired in real time, further utilizing sub-region data with labels generated by a virtual three-dimensional world simulation corresponding to the real-world scene images, further utilizing a pre-labelled real-world image and corresponding sub-region label data, and/or further utilizing scene images and label data collected by at least one other three-dimensional distance measurement device.

In step S607, outputting the scene distance information and scene image of the scene to be measured.

In at least one embodiment of the present disclosure, the output of the deep neural network is calibrated with label data of a simulated virtual 3D world as simple primitives and/or superpixel sub-regions including 3D information, and the simple primitives and/or superpixel sub-regions are used to generate the scene distance information for the target region. Usually, the output target (label data) of a general neural network for image recognition is a block diagram (boundary) of an object and the name of the object represented by the block diagram such as apple, tree, person, bicycle, car, and so on, and the output in the present embodiment is simple primitives such as triangles, rectangles, circles, and so on. In other words, in the processing of the three-dimensional distance measurement device, the target object is identified/simplified into “simple primitives” (including bright spots and dimensions, so-called “simple primitives”), and both the original image and the simple primitives are a part of the scene distance information that is generated for the target region. The three-dimensional distance measurement method according to at least one embodiment of the present disclosure outputs a 2D visual image and a 3D distance point cloud map.

As described above, the three-dimensional distance measurement method and device according to the embodiments of the present disclosure achieve accurate and real-time depth information acquisition without scanning and subject to a narrow field-of-view limitation by using an even normal CCD or CMOS image sensor with controllable illumination and sensor exposure imaging.

Those of ordinary skill in the art may realize that the units and algorithm steps of the examples described in conjunction with the embodiments disclosed herein can be implemented in electronic hardware, or a combination of computer software and electronic hardware. Whether these functions are performed in hardware or software depends on the specific application and design constraints of the technical solution. Those of ordinary skill in the art can use different methods to implement the described functions for each specific application, but such implementation should not be considered beyond the scope of the present disclosure.

The basic principles of the present disclosure are described above in conjunction with specific embodiments. However, it should be pointed out that the advantages, superiorities, effects, etc. mentioned in this disclosure are only examples rather than limitations, and these advantages, superiorities, effects, etc. cannot be considered as requirement for all the embodiments of the present disclosure. In addition, the specific details disclosed above are only for the purpose of illustration and ease of understanding, rather than limitation, and the above details do not limit the present disclosure to the implementation of the above specific details.

The block diagrams of the components, apparatuses, devices, and systems involved in the present disclosure are merely illustrative examples and are not intended to require or imply that the connections, arrangements, or configurations must be in the manner shown in the block diagrams. As those skilled in the art will recognize, these components, apparatuses, devices, systems may be connected, arranged, and configured in any manner. Words such as “include”, “comprise”, “have”, etc. are open-ended words that refer to “including but not limited to” and can be used interchangeably with them. The words “or” and “and” as used herein refer to the word “and/or” and can be used interchangeably unless the context clearly indicates otherwise. The word “such as” used herein refers to the phrase “such as but not limited to” and can be used interchangeably with it.

In addition, as used herein, “or” used in the enumeration of items beginning with “at least one” indicates a separate enumeration, so that, for example, an enumeration of “at least one of A, B, or C” means A or B or C, or AB or AC or BC, or ABC (i.e., A and B and C). Furthermore, the wording “exemplary” does not mean that the described example is preferred or better than other examples.

It should also be pointed out that in the system and method of the present disclosure, each component or each step can be decomposed and/or recombined. These decompositions and/or recombinations should be considered equivalents of the present disclosure.

Various changes, substitutions, and alterations to the techniques described herein can be made without departing from the techniques taught by the appended claims. Furthermore, the scope of the claims of the present disclosure is not limited to the specific aspects of the processes, machines, manufacture, event composition, means, methods, and actions described above. The processes, machines, manufacture, event composition, means, methods, and actions that currently exist or that will be developed later can be utilized to perform substantially the same functions or achieve substantially the same results as the corresponding aspects described herein. Accordingly, the appended claims include within their scope such the processes, machines, manufacture, event composition, means, methods, and actions.

The above description of the disclosed aspects is provided to enable any person skilled in the art to make or use the present disclosure. Various modifications to these aspects are obvious to those skilled in the art, and the general principles defined herein can be applied to other aspects without departing from the scope of the present disclosure. Therefore, the present disclosure is not intended to be limited to the aspects shown herein, but in accordance with the widest scope consistent with the principles and novel features disclosed herein.

The foregoing description is presented for the purposes of illustration and description. Furthermore, this description is not intended to limit the embodiments of the present disclosure to the forms disclosed herein. Although a plurality of example aspects and embodiments are discussed above, those skilled in the art will recognize certain variations, modifications, changes, additions and sub-combinations thereof.

1. A three-dimensional distance measurement device, comprising:
at least a light source unit, configured to emit light pulses to illuminate a scene to be measured;
at least an optical transmission unit, configured to control transmission of a reflected light obtained after the light pulses are reflected by an object in the scene to be measured;
at least a photoreceptor unit, configured to receive a light transmitted through the optical transmission unit to perform imaging; and
at least a processor unit, configured to control the light source unit, the optical transmission unit and the photoreceptor unit, and to determine scene distance information of the scene to be measured based on an imaging result of the photoreceptor unit, wherein
the light pulses comprise at least a first light pulse and a second light pulse, and a ratio of a first processed pulse envelope, which is obtained by processing a first pulse envelope of the first light pulse by the optical transmission unit, to a second processed pulse envelope, which is obtained by processing a second pulse envelope of the second light pulse by the optical transmission unit, is a monotonic function varying with time.

2. The three-dimensional distance measurement device according to claim 1, wherein the light source unit is configured to simultaneously or sequentially emit light pulses of different wavelengths, different polarizations, and different spatial structures and/or different temporal structures.

3. The three-dimensional distance measurement device according to claim 1, wherein the photoreceptor unit is configured to perform pixel-by-pixel or region-by-region imaging simultaneously or sequentially.

4. The three-dimensional distance measurement device according to claim 1, wherein the photoreceptor unit is configured to acquire a first scene image corresponding to the first light pulse, a second scene image corresponding to the second light pulse, and a background scene image of the scene to be measured; and
the processor unit is configured to acquire the scene distance information of the scene to be measured based on the background scene image, the first scene image and the second scene image.

5. The three-dimensional distance measurement device according to claim 4, wherein the background scene image comprises a background scene image obtained by imaging the scene to be measured in a wavelength band not comprising a wavelength of the first light pulse nor a wavelength of the second light pulse, and/or
a background scene image obtained by imaging the scene to be measured in a wavelength band comprising wavelengths of the first light pulse and the second light pulse while without the first light pulse and the second light pulse being emitted.

6. The three-dimensional distance measurement device according to claim 4, wherein the processor unit is configured to generate a target region image of corresponding to a target region comprising a plurality of sub-regions based on the first scene image, the second scene image and the background scene image, and the sub-regions comprise simple primitives and/or superpixel regions; and
the processor unit is configured to generate scene distance information of the target region based on the first scene image, the second scene image and the target region image.

7. The three-dimensional distance measurement device according to claim 6, wherein the target region image is generated using a deep neural network; and
the deep neural network is pre-optimized to perform sub-region segmentation based on the first scene image, the second scene image and the background scene image and generate the scene distance information based on the first scene image, the second scene image and the background scene image.

8. (canceled)

9. The three-dimensional distance measurement device according to claim 8, wherein the deep neural network is updated in real time utilizing real-world scene images, further utilizing sub-region data with labels generated by a virtual three-dimensional world simulation corresponding to the real-world scene images, further utilizing a pre-labelled real-world image and corresponding sub-region label data, and/or further utilizing scene images and label data collected by at least one other three-dimensional distance measurement device.

10. The three-dimensional distance measurement device according to claim 9, wherein an output of the deep neural network is calibrated with label data of a simulated virtual three-dimensional world as simple primitives and/or superpixel sub-regions comprising three-dimensional information, and the simple primitives and/or superpixel sub-regions are used to generate the scene distance information for the target region.

11. The three-dimensional distance measurement device according to claim 6, further comprising a beam splitter unit, configured to guide the reflected light reflected by the object in the scene to be measured to the optical transmission unit, and to guide the reflected light reflected by the object in the scene to be measured to the photoreceptor unit, wherein
the photoreceptor unit comprises at least a first photoreceptor sub-unit and a second photoreceptor sub-unit, the first photoreceptor sub-unit is configured to perform imaging on the reflected light, and the second photoreceptor sub-unit is configured to perform imaging on a reflected light of a natural light;
the first photoreceptor sub-unit is at least further configured to perform imaging with spatially uneven light pulses to generate an uneven light pulse scene image; and
the scene distance information is generated based on the background scene image, at least the first scene image and the second scene image, the target region image, and/or the uneven light pulse scene image.

12. The three-dimensional distance measurement device according to claim 1, wherein the three-dimensional distance measurement device is installed on a vehicle, and the light source unit is configured as a left headlight and/or a right headlight of the vehicle.

13. The three-dimensional distance measurement device according to claim 1, wherein the optical transmission unit comprises a first optical transmission sub-unit and/or a second optical transmission sub-unit, and the photoreceptor unit comprises a first photoreceptor sub-unit and a second photoreceptor sub-unit;
the three-dimensional distance measurement device further comprises a first beam splitter sub-unit and a second beam splitter sub-unit;
the first optical transmission sub-unit, the first beam splitter sub-unit and the first photoreceptor sub-unit form a first sub optical path for imaging the light pulses;
the second optical transmission sub-unit, the second beam splitter sub-unit and the second photoreceptor sub-unit form a second sub optical path for imaging a visible light;
the processor unit is configured to control alternate imaging or simultaneous imaging via the first sub optical path and/or the second sub optical path; and
the scene distance information is generated based on the background scene image, the first scene image and the second scene image, and the target region image.

14. The three-dimensional distance measurement device according to claim 13, further comprising an amplifier unit, configured after the light source unit for amplifying the light pulses, or configured after the first optical transmission sub-unit or the first beam splitter sub-unit for amplifying the reflected light, wherein
the processor unit is further configured to output the scene distance information and a scene image of the scene to be measured, and the scene image comprises at least one of the group consisting of an image of geometric figures and an optical flow image.

15. (canceled)

16. A three-dimensional distance measurement method, comprising:
emitting light pulses to illuminate a scene to be measured;
controlling transmission of a reflected light obtained after the light pulses are reflected by an object in the scene to be measured;
receiving a light transmitted through the transmission to perform imaging; and
determining scene distance information of the scene to be measured based on a result of the imaging, wherein
the light pulses comprise at least a first light pulse and a second light pulse, and a ratio of a first processed pulse envelope, which is obtained by processing a first pulse envelope of the first light pulse, to a second processed pulse envelope, which is obtained by processing a second pulse envelope of the second light pulse, is a monotonic function varying with time.

17. The three-dimensional distance measurement method according to claim 16, wherein emitting the light pulses comprises:
simultaneously or sequentially emitting light pulses of different wavelengths, different polarizations, and different spatial structures and/or different temporal structures; and
the three-dimensional distance measurement method further comprises:
performing pixel-by-pixel or region-by-region imaging simultaneously or sequentially.

18. (canceled)

19. The three-dimensional distance measurement method according to claim 16, further comprising:
acquiring a first scene image corresponding to the first light pulse, a second scene image corresponding to the second light pulse, and a background scene image of the scene to be measured; and
acquiring the scene distance information of the scene to be measured based on the background scene image, the first scene image and the second scene image.

20. The three-dimensional distance measurement method according to claim 16, wherein the background scene image comprises a background scene image obtained by imaging the scene to be measured in a wavelength band not comprising a wavelength of the first light pulse nor a wavelength of the second light pulse, and/or
a background scene image obtained by imaging the scene to be measured in a wavelength band comprising wavelengths of the first light pulse and the second light pulse while without the first light pulse and the second light pulse being emitted.

21. The three-dimensional distance measurement method according to claim 19, further comprising:
generating a target region image of corresponding to a target region comprising a plurality of sub-regions based on the first scene image, the second scene image and the background scene image, wherein the sub-regions comprise simple primitives and/or superpixel regions; and
generating scene distance information of the target region based on the first scene image, the second scene image and the target region image.

22. The three-dimensional distance measurement method according to claim 21, further comprising:
pre-optimizing a deep neural network to perform sub-region segmentation based on the first scene image, the second scene image and the background scene image and generate the scene distance information based on the first scene image, the second scene image and the background scene image.

23. The three-dimensional distance measurement method according to claim 22, further comprising:
updating the deep neural network in real time utilizing real-world scene images, further utilizing sub-region data with labels generated by a virtual three-dimensional world simulation corresponding to the real-world scene images, further utilizing a pre-labelled real-world image and corresponding sub-region label data, and/or further utilizing scene images and label data collected by at least one other three-dimensional distance measurement device.
